(19) United States
(12) Patent Application Publication
(10) Pub. No.: US 2009/0206688 A1
(43) Pub. Date: Aug. 20, 2009

(54) COOLING STRUCTURE FOR STATOR

(76) Inventors: Shinya Sano, Toyota-shi (JP); Kazutaka Tatematsu, Nagoya-shi (JP); Tomoka Sonohara, Toyota-shi (JP); Atomi Arakawa, Anjo-shi (JP)

Correspondence Address: KENYON & KENYON LLP, 1500 K STREET N.W., SUITE 700, WASHINGTON, DC, 20005, US

(21) Appl. No.: 12/363,894

(22) Filed: Feb. 2, 2009

(30) Foreign Application Priority Data
Feb. 18, 2008 (JP) 2008-036019

(51) Int. Cl. H02K 9/16

(52) U.S. Cl. 310/58

(57) ABSTRACT

A cooling structure for a stator includes: a stator core; a stator coil that is wound on the stator core and includes a coil end formed on an end surface of the stator core in an axial direction of the stator core; a ring member provided on an outer periphery of the stator core; a case that houses the ring member and the stator core on which the stator coil is wound. In the cooling structure, a cooling medium is supplied between an outer peripheral surface of the ring member and an inner peripheral surface of the case, and the ring member includes at least one opening through which the cooling medium is supplied to the coil end from radially outside of the coil end.

### INCORPORATION BY REFERENCE

The disclosure of Japanese Patent Application No. 2008-036019 filed on Feb. 18, 2008 including the specification, drawings and abstract is incorporated herein by reference in its entirety.

### BACKGROUND OF THE INVENTION

1. Field of the Invention

The invention relates to a cooling structure for a stator, and in particular, relates to a cooling structure for a stator in which a ring member is provided on an outer periphery of a stator core.

2. Description of the Related Art

Japanese Patent Application Publication No. 2003-88013 (JP-A-2003-88013) describes that an intermediate ring, which is a thin cylindrical shape, is fitted on an outer periphery of a stator core by means of shrink fitting, and a small clearance is formed between an outer peripheral surface of the intermediate ring and an inner peripheral surface of a casing so as to allow cooling oil to flow through the clearance.

Japanese Patent Application Publication No. 2001-268849 (JP-A-2001-268849) describes that a cooling fluid passage is provided between a retaining ring of the stator core and the inner peripheral surface of the case.

Japanese Patent Application Publication No. 2005-253263 (JP-A-2005-253263) and Japanese Patent Application Publication No. 2005-229671 (JP-A-2005-229671) describe that the oil or air is supplied to coil ends of a stator coil.

When the stator is configured so that the cooling medium is supplied to the coil ends of the stator coil, it may be desired to flexibly set the position of a cooling medium supply portion in a circumferential direction of the stator core.

JP-A-2003-88013 and JP-A-2001-268849 describe that the cooling medium is supplied between the case and the ring provided on the outer periphery of the stator core. However, because cooling oil flows in an axial direction of the stator core in the configuration described in JP-A-2003-88013, it is not possible to flexibly set the position of the cooling oil passage in the circumferential direction of the stator core. Further, JP-A-2001-268849 does not even mention the concept of supplying the cooling fluid that flows through the cooling fluid passage to the coil ends.

JP-A-2005-253263 and JP-A-2005-229671 describe that the cooling medium is supplied to the coil ends of the stator coil. However, in JP-A-2005-253263, an oil pipe needs be provided above the stator, and in JP-A-2005-229671, the air is supplied through holes formed in the case. In either case, flexible positioning of a cooling medium passage in the circumferential direction may be restricted.

### SUMMARY OF THE INVENTION

The invention provides a cooling structure for a stator by which cooling efficiency is improved.

A cooling structure for a stator according to a first aspect of the invention includes: a stator core; a stator coil that is wound on the stator core and includes a coil end formed on an end surface of the stator core in an axial direction of the stator core; a ring member provided on an outer periphery of the stator core; a case that houses the ring member and the stator core on which the stator coil is wound. In the cooling structure, a cooling medium is supplied between an outer peripheral surface of the ring member and an inner peripheral surface of the case, and the ring member includes at least one opening through which the cooling medium is supplied to the coil end from radially outside of the coil end.

In the aforementioned configuration, the cooling medium is supplied between the outer peripheral surface of the ring member and the inner peripheral surface of the case, and therefore, it is possible to improve heat transfer efficiency between the stator core and the case. Further, in the aforementioned configuration, it is possible to flexibly set the position of the opening in the ring member, whereby the cooling medium is easily supplied to the desired portion of the stator. This makes it possible to more effectively cool the coil end of the stator coil.

A cooling structure for a stator according to a second aspect of the invention includes: a stator core; a stator coil that is wound on the stator core and includes respective coil ends formed on both end surfaces of the stator core in an axial direction of the stator core; a ring member provided on an outer periphery of the stator core; a case that houses the ring member and the stator core on which the stator coil is wound. In the cooling structure, a cooling medium is supplied between an outer peripheral surface of the ring member and an inner peripheral surface of the case, and the ring member includes at least one opening through which the cooling medium is supplied to the coil ends formed on the both end surfaces of the stator core in the axial direction of the stator core.

In this configuration, it is possible to supply the cooling medium to the coil ends disposed on the both end surfaces of the stator core in the axial direction of the stator core. This makes it possible to more effectively cool the coil ends of the stator coil.

A cooling structure for a stator according to a third aspect of the invention includes: a stator core; a stator coil that is wound on the stator core and includes a coil end formed on a surface of one end portion of the stator core in an axial direction of the stator core; a ring member provided on an outer periphery of the stator core; a case that houses the ring member and the stator core on which the stator coil is wound. In the cooling structure, a cooling medium is supplied between an outer peripheral surface of the ring member and an inner peripheral surface of the case, and the ring member includes an extension portion that extends beyond the one end portion of the stator core in the axial direction of the stator core. Further, at least one opening is formed in the extension portion so as to supply the cooling medium to the coil end of the stator coil.

In this configuration, it is possible to supply the cooling medium to the coil end disposed on the end surface of the stator core in the axial direction of the stator core. This makes it possible to more effectively cool the coil end of the stator coil.

In the aforementioned aspects, the stator core may include a plurality of stator core segments arranged in a circumferential direction of the stator core, and the ring member may clamp the plurality of stator core segments.

In this configuration, it is possible to store the cooling medium using the ring member that clamps the stator core segments. This makes it possible to more effectively cool the stator, while suppressing increase of the number of components and increase of cost.

In the aforementioned aspects, a clearance may be formed between the outer peripheral surface of the ring member and the inner peripheral surface of the case so that the cooling medium is supplied to the clearance, and the clearance may be closed at both ends of the ring member in the axial direction of the stator core.

In this configuration, it is possible to avoid leaking of the cooling medium stored in the clearance between the outer peripheral surface of the ring member and the inner peripheral surface of the case from both ends of the ring member in the axial direction of the stator core. This makes it possible to further more effectively cool the stator.

In the aforementioned aspects, a plurality of the openings may be arranged in a circumferential direction of the stator core.

In the aforementioned aspects, a plurality of the openings may be arranged in the axial direction of the stator core.

In the aforementioned aspects, the case may be provided with a cooling medium passage so that the cooling medium flows through the cooling medium passage and is supplied between the outer peripheral surface of the ring member and the inner peripheral surface of the case.

According to the invention, it is possible to improve the cooling efficiency of the stator.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 shows a configuration of a drive unit that includes a cooling structure for a stator according to an embodiment of the invention;

FIG. 2 is a front view of the cooling structure for a stator according to the embodiment of the invention;

FIG. 3 is a longitudinal cross-sectional view taken along the line III-III shown in FIG. 2;

FIG. 4 is an enlarged view showing the region A shown in FIG. 3; and

FIG. 5 is an enlarged view showing a modification example of the region A shown in FIG. 3.

### DETAILED DESCRIPTION OF THE PREFERRED EMBODIMENTS

An embodiment of the invention will be hereinafter described with reference to the attached drawings. The same or equivalent components are denoted by same reference numerals, and the description thereof will not be repeated.

In the embodiment to be described below, if the number or amount is mentioned, the scope of the invention is not limited to the specific number or amount mentioned in this specification, unless otherwise specifically determined. Further, in the embodiment below, each constituent element is not necessarily essential to the configuration of the invention, unless otherwise specifically determined. Yet further, if there are two or more embodiments in this specification, it is originally intended to appropriately combine the configurations of the embodiments, unless otherwise specifically determined.

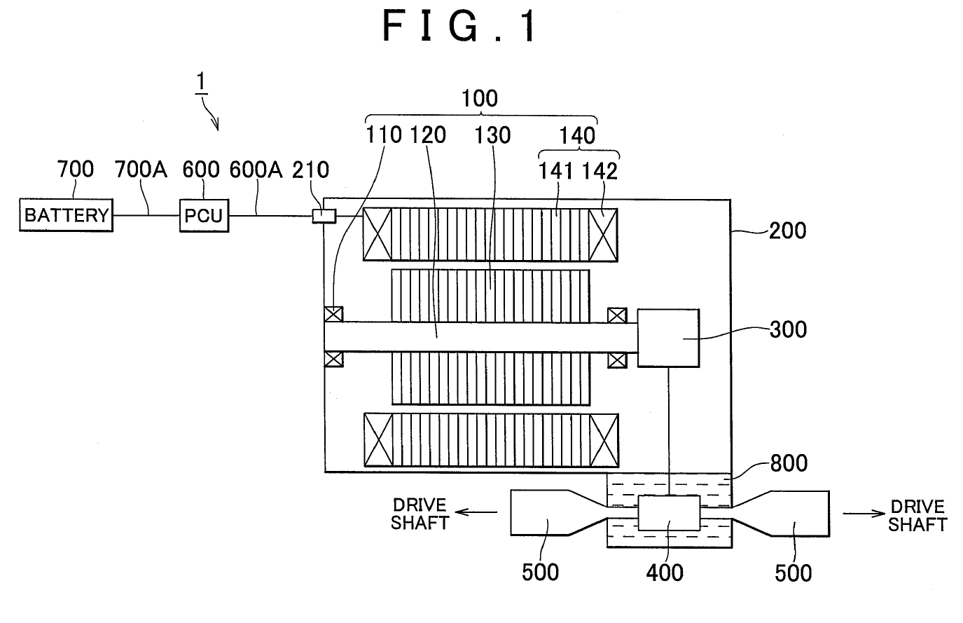

FIG. 1 shows a configuration of a drive unit that includes a cooling structure for a stator according to the embodiment of the invention. In the example shown in FIG. 1, a drive unit 1 is mounted on a hybrid vehicle that functions as an “electrically-operated vehicle”. The drive unit 1 includes a motor-generator 100, a case 200, a speed reduction mechanism 300, a differential mechanism 400, and drive shaft couplings 500.

The motor-generator 100 functions as an electric motor or a power generator, and includes a rotating shaft 120 that is rotatably attached to the case 200 through bearings 110, a rotor 130 that is attached to the rotating shaft 120, and a stator 140. The stator 140 includes a stator core 141, and the stator core 141 includes portions on which stator coils 142 are wound. The stator coils 142 are electrically connected to one end of a power cable 600A through a terminal block 210 provided for the case 200. The other end of the power cable 600A is connected to a power control unit (hereinafter abbreviated as “PCU”) 600. The PCU 600 is electrically connected to a battery 700 through a power cable 700A. In this way, the stator coils 142 are electrically connected to the battery 700. The motor-generator 100 is disposed in a manner such that an axis of the rotating shaft 120 extends in a substantially horizontal direction.

The power output from the motor-generator 100 is transmitted from the speed reduction mechanism 300 to the drive shaft couplings 500 through the differential mechanism 400. Then, the power transmitted to the drive shaft couplings 500 is further transmitted, as a rotating force, to respective wheels (not shown) through the drive shafts (not shown), whereby the vehicle runs.

When the hybrid vehicle is under regenerative braking, the wheels are rotated by a force of inertia of a vehicle body. The rotating force produced by the wheels drives the motor-generator 100 through the drive shaft couplings 500, the differential mechanism 400, and the speed reduction mechanism 300. The motor-generator 100 thus operates as a power generator. The power generated by the motor-generator 100 is stored in the battery 700 through an inverter included in the PCU 600.

Each of the power cables 600A and 700A is a three-phase cable that includes a U-phase cable, a V-phase cable, and a W-phase cable. The stator coils 142 include a U-phase coil, a V-phase coil, and a W-phase coil, and terminals of three types of coils are connected to the U-phase cable, the V-phase cable, and the W-phase cable of the power cable 600A, respectively.

An oil 800 is stored in a bottom portion of the case 200. The oil 800 is stirred upward as a ring gear in the differential mechanism 400 rotates, and circulated in the case 200 and then returned to the bottom portion of the case 200. The oil 800 supplied to various portions in the case 200 cools and lubricates the portions to which the oil 800 is supplied.

It should be noted that the motor-generator 100 is not limited to the application in the hybrid vehicle, and may be mounted on other type of “electrically-operated vehicle” (for example, a fuel cell vehicle and an electric vehicle).

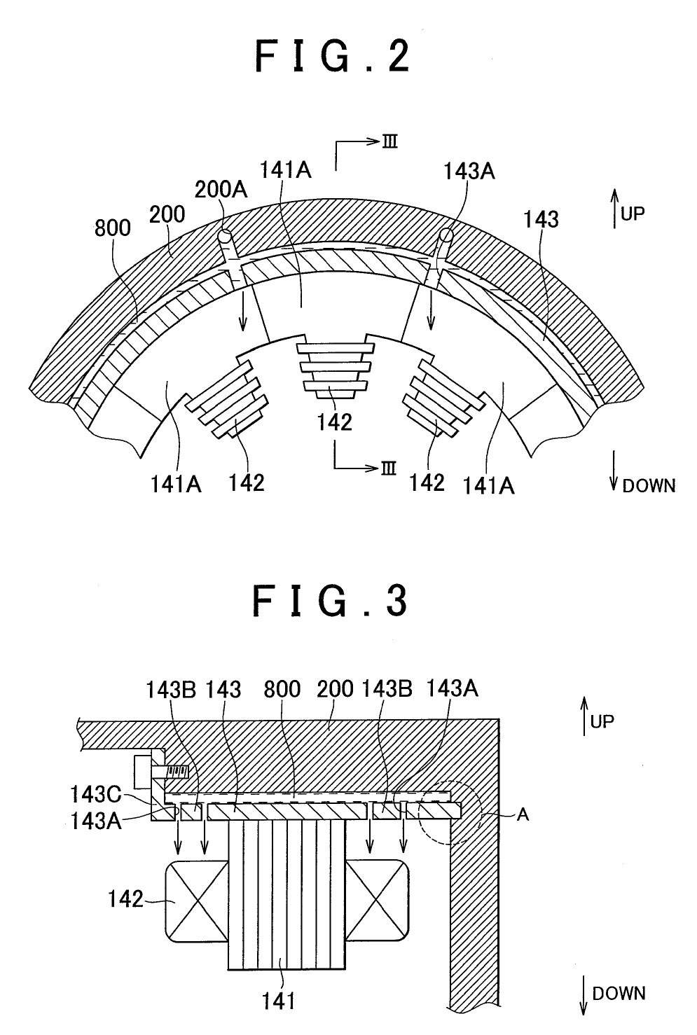

FIG. 2 is a front view of the cooling structure for a stator according to the embodiment of the invention. Referring to FIG. 2, the stator core 141 is formed of a plurality of stator core segments 141A arranged in a circumferential direction. The plurality of stator core segments 141A are clamped by a clamping ring 143 from radially outside of the stator core segments 141A. A clearance is formed between an outer peripheral surface of the clamping ring 143 and an inner peripheral surface of the case 200. The case 200 is provided with oil passages 200A through which the oil 800 flows. The oil 800 flows through the oil passages 200A and is supplied to the clearance between the outer peripheral surface of the clamping ring 143 and the inner peripheral surface of the case 200. Further, the oil 800 flows toward respective coil ends of the stator coils 142 formed on end surfaces of the stator core 141 in an axial direction of the stator core 141 (hereinafter simply referred to as “coil ends”) through openings 143A provided on the clamping ring 143.

In the embodiment, the oil 800 that has passed through the oil passages 200A provided in the case 200 is temporarily stored in the clearance between the outer peripheral surface of the clamping ring 143 and the inner peripheral surface of the case 200. Because heat transfer coefficient of the oil 800 is higher (approximately 3 times higher) than heat transfer coefficient of the air, it is possible to improve the efficiency of heat transfer from the stator 140 to the case 200 by filling the oil 800 in the clearance between the clamping ring 143 and the case 200. As a result, the stator 140 is more effectively cooled.

Further, in the embodiment, the oil 800 stored in the clearance between the clamping ring 143 and the case 200 is supplied to the coil ends of the stator coils 142 through the openings 143A. It is possible to relatively flexibly set the positions of the openings 143A in the circumferential direction in the clamping ring 143. Therefore, because the oil 800 is supplied to the stator coils 142 through the openings 143A formed in the clamping ring 143 as described above, instead of supplying the oil 800 to the stator coils 142 directly from the oil passages 200A provided in the case 200, the positions at which the oil 800 is supplied to the coil ends of the stator coils 142 may be relatively flexibly set in the circumferential direction in the clamping ring 143, and this makes it possible to evenly supply the oil 800 to the coil ends of the stator coils 142 in the circumferential direction of the stator 140. As a result, it is possible to more effectively cool the stator 140. For example, in the example shown in FIG. 2, two of the openings 143A are arranged in the circumferential direction near a top portion of the case 200. However, the position(s) and number of the opening(s) 143A in the circumferential direction may be appropriately changed (may be one or two or more).

FIG. 3 is a longitudinal cross-sectional view taken along the line III-III in FIG. 2. Referring to FIG. 3, the clamping ring 143 includes extension portions 143B that extend beyond both ends of the stator core 141 in the axial direction thereof, and the openings 143A are formed on the extension portions 143B. In the example shown in FIG. 3, two of the openings 143A are formed in each of the extension portions 143B, which are disposed on the respective sides of the ends of the stator core 141 in the axial direction thereof. In this example, the two openings 143A are arranged in the axial direction of the stator core 141. However, the position(s) and number of the opening(s) 143A in the axial direction of the stator core 141 may be appropriately changed (may be one or two or more). For example, two of the openings 143A may be provided only in either of the extension portions 143B, or only one opening 143A may be provided on each of the extension portions 143B.

As shown in FIG. 3, in the embodiment, the clearance between the outer peripheral surface of the clamping ring 143 and the inner peripheral surface of the case 200 is closed at both ends of the clamping ring 143 in the axial direction of the stator core 141. In this configuration, it is possible to avoid leaking of the oil 800 stored in the clearance between the outer peripheral surface of the clamping ring 143 and the inner peripheral surface of the case 200 from the both ends of the clamping ring 143 in the axial direction of the stator core 141. This makes it possible to effectively use the stored oil between the clamping ring 143 and the case 200, whereby the stator 140 is further more effectively cooled.

The clamping ring 143 includes a flange portion 143C formed at one of the ends of the clamping ring 143 in the axial direction of the stator core 141 (that is, the end on the left shown in FIG. 3; the end will be hereinafter simply referred to as “the one end”). The clamping ring 143 is fixed to the case 200 by fixing the flange portion 143C to the case 200 by means of a bolt. This closes the clearance between the clamping ring 143 and the case 200 at the one end of the clamping ring 143.

Further, the other end of the clamping ring 143 in the axial direction of the stator core 141 (that is, the end on the right shown in FIG. 3; the end will be hereinafter simply referred to as “the other end”) is brought in contact with a side surface of the case 200 so as to close the clearance between the clamping ring 143 and the case 200 at the other end of the clamping ring 143.

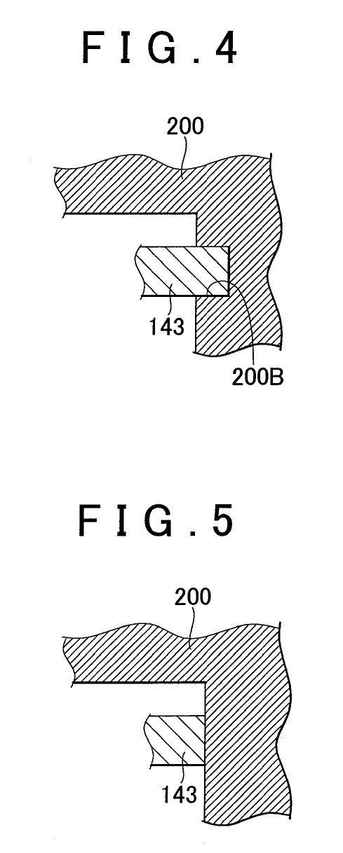

FIG. 4 is an enlarged view showing the region A shown in FIG. 3. Referring to FIG. 4, a groove portion 200B is formed on the side surface of the case 200. The other end of the clamping ring 143 is inserted into the groove portion 200B so as to close the clearance between the clamping ring 143 and the case 200.

FIG. 5 is an enlarged view showing a modification example of the region A shown in FIG. 3. In the modification example shown in FIG. 5, the other end of the clamping ring 143 simply abuts the side surface of the case 200, instead of forming the groove portion 200B on the side surface of the case 200. Even in this configuration shown as the modification example in FIG. 5, it is possible to close the clearance between the clamping ring 143 and the case 200.

The description of the embodiment will be summarized as follows. The cooling structure for a stator according to the embodiment includes: the stator core 141; the stator coil 142 that is wound on the stator core 141 and includes the coil end formed on the end surface of the stator core 141 in an axial direction of the stator core; the clamping ring 143 that is provided on an outer periphery of the stator core 141 and functions as a “ring member”; and the case 200 that houses the stator core 141 on which the stator coil 142 is wound and the clamping ring 143. In the cooling structure, the oil 800, which functions as the “cooling medium”, is supplied between an outer peripheral surface of the clamping ring 143 and an inner peripheral surface of the case 200.

The clamping ring 143 includes the openings 143A through which the oil 800 is supplied to the coil end from radially outside of the coil end. In the example shown in FIG. 3, the openings 143A are formed so that the oil 800 is supplied to the respective coil ends of the stator coil 142 formed on both end surfaces of the stator core 141 in the axial direction thereof. Further, the clamping ring 143 includes the respective extension portions 143B that extend beyond the both ends of the stator core 141 in the axial direction thereof. The openings 143A are formed on the extension portions 143B.

In the embodiment, the configuration in which the plurality of stator core segments 141A are clamped by the clamping ring 143 is exemplified. However, the invention is not limited to this configuration, and may be applied to the stator core 141 that is integrally formed in the circumferential direction of the stator core 141.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A cooling structure for a stator, comprising:
a stator core;
a stator coil that is wound on the stator core and includes a coil end formed on an end surface of the stator core in an axial direction of the stator core;
a ring member provided on an outer periphery of the stator core;
a case that houses the ring member and the stator core on which the stator coil is wound, wherein
a cooling medium is supplied between an outer peripheral surface of the ring member and an inner peripheral surface of the case, and the ring member includes at least one opening through which the cooling medium is supplied to the coil end from radially outside of the coil end.

2. The cooling structure according to claim 1, wherein the stator core includes a plurality of stator core segments arranged in a circumferential direction of the stator core, and the ring member clamps the plurality of stator core segments.

3. The cooling structure according to claim 1, wherein:
a clearance is formed between the outer peripheral surface of the ring member and the inner peripheral surface of the case so that the cooling medium is supplied to the clearance; and
the clearance is closed at an end of the ring member in the axial direction of the stator core.

4. The cooling structure according to claim 1, wherein a plurality of the openings are arranged in a circumferential direction of the stator core.

5. The cooling structure according to claim 1, wherein a plurality of the openings are arranged in the axial direction of the stator core.

6. The cooling structure according to claim 1, wherein the case is provided with a cooling medium passage so that the cooling medium flows through the cooling medium passage and is supplied between the outer peripheral surface of the ring member and the inner peripheral surface of the case.

7. A cooling structure for a stator, comprising:
a stator core;
a stator coil that is wound on the stator core and includes respective coil ends formed on both end surfaces of the stator core in an axial direction of the stator core;
a ring member provided on an outer periphery of the stator core;
a case that houses the ring member and the stator core on which the stator coil is wound, wherein
a cooling medium is supplied between an outer peripheral surface of the ring member and an inner peripheral surface of the case, and the ring member includes at least one opening through which the cooling medium is supplied to the coil ends formed on the both end surfaces of the stator core in the axial direction of the stator core.

8. The cooling structure according to claim 7, wherein the stator core includes a plurality of stator core segments arranged in a circumferential direction of the stator core, and the ring member clamps the plurality of stator core segments.

9. The cooling structure according to claim 7, wherein:
a clearance is formed between the outer peripheral surface of the ring member and the inner peripheral surface of the case so that the cooling medium is supplied to the clearance; and
the clearance is closed at an end of the ring member in the axial direction of the stator core.

10. The cooling structure according to claim 7, wherein a plurality of the openings are arranged in a circumferential direction of the stator core.

11. The cooling structure according to claim 7, wherein a plurality of the openings are arranged in the axial direction of the stator core.

12. The cooling structure according to claim 7, wherein the case is provided with a cooling medium passage so that the cooling medium flows through the cooling medium passage and is supplied between the outer peripheral surface of the ring member and the inner peripheral surface of the case.

13. A cooling structure for a stator, comprising:
a stator core;
a stator coil that is wound on the stator core and includes a coil end formed on a surface of one end portion of the stator core in an axial direction of the stator core;
a ring member provided on an outer periphery of the stator core;
a case that houses the ring member and the stator core on which the stator coil is wound, wherein
a cooling medium is supplied between an outer peripheral surface of the ring member and an inner peripheral surface of the case;
the ring member includes an extension portion that extends beyond the one end portion of the stator core in the axial direction thereof; and
at least one opening is formed on the extension portion so as to supply the cooling medium to the coil end of the stator coil.

14. The cooling structure according to claim 13, wherein the stator core includes a plurality of stator core segments arranged in a circumferential direction of the stator core, and the ring member clamps the plurality of stator core segments.

15. The cooling structure according to claim 13, wherein:
a clearance is formed between the outer peripheral surface of the ring member and the inner peripheral surface of the case so that the cooling medium is supplied to the clearance; and
the clearance is closed at an end of the ring member in the axial direction of the stator core.

16. The cooling structure according to claim 13, wherein a plurality of the openings are arranged in a circumferential direction of the stator core.

17. The cooling structure according to claim 13, wherein a plurality of the openings are arranged in the axial direction of the stator core.

18. The cooling structure according to claim 13, wherein the case is provided with a cooling medium passage so that the cooling medium flows through the cooling medium passage and is supplied between the outer peripheral surface of the ring member and the inner peripheral surface of the case.
